(19) United States
(12) Patent Application Publication
(10) Pub. No.: US 2024/0001252 A1
(43) Pub. Date: Jan. 4, 2024

(54) ELECTRICALLY CONDUCTIVE TOY BUILDING BLOCKS

(71) Applicant: Mark VAUGHAN, West Vancouver (CA)

(72) Inventor: Mark VAUGHAN, West Vancouver (CA)

(21) Appl. No.: 18/143,508

(22) Filed: May 4, 2023

Related U.S. Application Data
(60) Provisional application No. 63/338,330, filed on May 4, 2022.

(51) Int. Cl. A63H 33/04; A63H 33/08

(52) U.S. Cl. CPC A63H 33/042; A63H 33/086

(57) ABSTRACT

An electrically conducting toy building block comprising: a body having a top surface and a bottom surface, and a plurality of evenly spaced connector studs projecting from the top surface, and an internal cavity that is open to the bottom surface and is sized to accommodate the top surface of another block and frictionally engage the connector studs of said other block to enable multiple blocks to be connected. The connectors studs comprise electrically non-conductive studs and electrically conductive studs. The electrically conductive connector studs comprise a top portion having external dimensions matching the non-electrically conducting stud, and an elongate telescoping member that extends downward from the top portion into the cavity. The telescoping member comprises an outer barrel and an inner plunger slidably received in the barrel, the plunger including a stop to prevent complete withdrawal of the plunger from the barrel, and the plunger being biased towards being extended from the barrel. The telescoping member having a length that when the plunger is fully extended from the barrel, a bottom of the plunger is within the cavity proximate the bottom surface, and when the block is connected to the top surface of another block, one connector stud on that block contacts the bottom of the plunger and urges the plunger inward.

### FIELD OF THE INVENTION

The disclosure relates to children's building block toys, and more particularly to educational electronic building block toys and systems.

### BACKGROUND OF THE INVENTION

Toy building bricks or blocks and toy building block sets comprising pluralities of such blocks, such as those sold by the LEGO™ Group of companies are well known. Other examples of toy building blocks of the type to which the invention relates have been described, for example, in U.S. Pat. Nos. 3,005,282 and 6,645,033, the entireties of which are incorporated herein by reference. Such toy blocks typically comprise hollow box-shaped blocks having flat tops with coupling members in the shape of cylindrical projections known as studs that protrude from the top. The connector studs are located at evenly spaced positions in regular arrangements of rows and columns. Downward facing hollow cavities form the bottom of the blocks and they contain coupling members that are positioned to fall between the studs on the top of an underlying block which creates a friction connection to the studs along with the sides of the block.

Toy blocks are amazingly popular toys for children of all ages. The appeal of these toys comes not only from the ease of construction and the quantity of different shapes, but more importantly from the infinite number of combinations that are possible with these blocks. In recent years the variety of block components on the market has increased as the patent on the basic LEGO TM building block has expired and inventors have created more and more systems that expand the original intent of these blocks. New systems include gears, lights, motors and more and more shapes.

Despite the attempts to create a building block system that easily allows for blocks to conduct electricity effectively through the system, there still remains a need for a simple and easy way to do so. Most prior art devices have focused on creating an electrically safe block that can not be short circuited and that can be utilized by children with no knowledge of how electronics work. In contrast, the present invention provides a teaching device and system that allows complete control of the circuit by the user thereby creating more flexibility and potential uses of the electronically conductive building blocks.

### SUMMARY OF THE INVENTION

The present invention provides a simplified modularized contact type of conductive toy building block. The toy building block is of a type which may be interconnected with similarly configured blocks, has a hollow box-shaped structure having a top with cylindrical stud coupling members, and sides which together with the top define a downwardly opening cavity into which the cylindrical studs of a like configured block may be inserted for frictional interconnection.

The toy blocks of the present invention include at least one pressure loaded conductive stud that extends from the top of the block through the opening cavity to make a pressure connection to studs that are inserted within. Multiple conductive studs located in a regular pattern on a single block may be connected with a conductive connector. The conductive connector between studs can be formed within the plastic or snapped in place. The connector may be a simple wire, metal piece or a circuit board that may or may not contain embedded components.

The present invention provides a system of electronic connections within the building blocks that is entirely unique by utilizing pressure connections. Not only that, but the system is designed to only carry one electrical connection per conductive connector stud, thus relying on the person connecting the blocks to create functional circuits. The purpose of this is to not only use the blocks themselves to create complex circuits as parts of robots or intelligent machines used in the Internet of Things (IOT), but to use the blocks to teach how electronic circuits work.

In one aspect, the present invention provides an electrically conducting toy building block comprising: a body having a top surface and a bottom surface, and a plurality of evenly spaced connector studs projecting from the top surface; the body defining an internal cavity that is open to the bottom surface and is sized to accommodate the top surface of another block and frictionally engage the connector studs of said other block for friction fit therebetween such that multiple blocks can be connected in a manner that each connector stud is frictionally engaged within the cavity of an adjacent block; wherein the connectors studs comprise at least one electrically non-conductive connector stud and at least one electrically conductive connector stud; wherein the electrically conductive connector stud comprises: a top portion having external dimensions matching the non-electrically conducting connector stud; an elongate telescoping member that extends downward from the top portion into the cavity, the telescoping member having an outer barrel and an inner plunger that is slidably received in the barrel, the plunger including a stop member to prevent complete withdrawal of the plunger from the barrel, the plunger being biased towards being extended from the barrel; and the telescoping member having a length that when the plunger is fully extended from the barrel, a bottom of the plunger is within the cavity proximate the bottom surface, and when the block is connected to the top surface of said another block one of the connector studs on said another block contacts the bottom of the plunger and urges the plunger inward.

In some embodiments, the toy building block may further comprise a spring connected to the plunger to bias the plunger towards being extended from the barrel.

In some embodiments, the toy building block may further comprise a coil spring within the telescoping member and connected to the plunger to bias the plunger towards being extended from the barrel.

In some embodiments, the toy building block may comprise at least two electrically conductive connector studs.

In some embodiments, the toy building block may further comprise an electrically conductive element connecting the at least two electrically conductive connector studs.

In some embodiments, electrically conductive connector stud may include a ring portion extending around the telescoping member near the top portion of the electrically conductive connector stud that defines an annular channel between the ring portion and the top portion and the annular channel is within the cavity.

In some embodiments, the electrically conductive element is received in the annular channels of the at least two electrically conductive connector studs.

In some embodiments, the electrically conductive element may comprise an integrated circuit board having an electrical circuit connecting the at least two electrically conductive connector studs.

In some embodiments, the integrated circuit board is received in the annular channels of the at least two electrically conductive connector studs.

In another aspect, the present invention provides an electrically conducting toy building block comprising: an external body having a top wall and side walls, the top wall defining a top surface, and the side walls defining a bottom edge, and the top wall and side walls bounding a cavity; a plurality of non-conductive connector studs projecting from the top surface and evenly spaced thereon, and a plurality of holes in the top wall evenly spaced from adjacent non-conductive connector studs of the plurality of non-conductive connector studs; a plurality of electrically conductive connector studs within the cavity, each electrically conductive connector stud of the plurality of electrically conductive connector studs having a top portion protruding through one of the plurality of holes, the top portion having external dimensions matching the non-electrically conducting connector studs, each electrically conductive connector stud of the plurality of electrically conductive connector studs further having an elongate telescoping member that extends downward from the top portion within the cavity, the telescoping member having an outer barrel and an inner plunger that is slidably received in the barrel, the plunger including a stop member to prevent complete withdrawal of the plunger from the barrel, the plunger being biased towards being extended from the barrel; and the telescoping member having a length that when the plunger is fully extended from the barrel, a bottom of the plunger is within the cavity proximate a bottom surface defined by the bottom edge; an electrically conductive element within the cavity adjacent the top wall, the electrically conductive element providing an electric circuit between at least two of the plurality of electrically conductive connector studs; an internal member within the cavity adjacent the electrically conductive element, the internal member having equally spaced projections extending into the cavity, wherein the equally spaced projections define at least a portion of a plurality of engagement portions in the cavity that frictionally engage the connector studs of said other block for friction fit therebetween such that multiple blocks can be connected in a manner that each connector stud is frictionally engaged within the cavity of an adjacent block; and wherein when the block is connected to the top surface of said another block the bottom of the plunger may be urged inward by contact with an electrically conductive connector stud on said another block.

In some embodiments, the electrically conducting toy building block may further comprise a spring connected to the plunger to bias the plunger towards being extended from the barrel.

In some embodiments, the electrically conducting toy building block may further comprise a coil spring within the telescoping member and connected to the plunger to bias the plunger towards being extended from the barrel.

In some embodiments, the electrically conducting toy building block may further comprise a clip mechanism cooperating with the external body and the internal member to secure the second internal member to the external body within the cavity.

In some embodiments, the mechanism may comprise a clasp portion on the side walls within the first cavity that captures the internal member upon the internal member being pressed into the first cavity.

In another aspect, the present invention provides an electrically conducting toy building block comprising: a top portion having a top wall and first side walls, the top wall defining a top surface, and the first side walls defining a bottom edge, and the top wall and first side walls bounding a first cavity to receive an electronic component; a bottom portion having second side walls defining a top edge and a second bottom edge, the second side walls bounding a second cavity; the bottom portion being connected to the top portion in a manner such that the fist side walls align with the second side walls to create a unified block; a plurality of non-conductive connector studs projecting from the top surface and evenly spaced thereon, and a plurality of holes in the top wall evenly spaced from adjacent non-conductive connector studs of the plurality of non-conductive connector studs; a plurality of electrically conductive connector studs within the cavity, each electrically conductive connector stud of the plurality of electrically conductive connector studs having a top portion protruding through one of the plurality of holes, the top portion having external dimensions matching the non-electrically conducting connector studs, each electrically conductive connector stud of the plurality of electrically conductive connector studs further having an elongate telescoping member that extends downward from the top portion within the first cavity and the second cavity, the telescoping member having an outer barrel and an inner plunger that is slidably received in the barrel, the plunger including a stop member to prevent complete withdrawal of the plunger from the barrel, the plunger being biased towards being extended from the barrel, and the telescoping member having a length that when the plunger is fully extended from the barrel, a bottom of the plunger is within the second cavity proximate a bottom surface defined by the second bottom edge; the second cavity having equally spaced projections extending into the cavity, wherein the equally spaced projections define at least a portion of a plurality of engagement portions in the cavity that frictionally engage the connector studs of said other block for friction fit therebetween such that multiple blocks can be connected in a manner that each connector stud is frictionally engaged within the cavity of an adjacent block; and wherein when the block is connected to the top surface of said another block the bottom of the plunger may be urged inward by contact with an electrically conductive connector stud on said another block.

In some embodiments, the electrically conducting toy building block may further comprise a spring connected to the plunger to bias the plunger towards being extended from the barrel.

In some embodiments, the electrically conducting toy building block may further comprise a coil spring within the telescoping member and connected to the plunger to bias the plunger towards being extended from the barrel.

In some embodiments, the electrically conducting toy building block may further comprise a clip mechanism cooperating with the top portion and the bottom portion to secure the top portion to the bottom portion.

In some embodiments, the clip mechanism may comprise a clasp portion extending from the first bottom edge and a complementary aligned void on the second side wall that captures the clasp portion as the bottom portion is pressed into abutment with the top portion.

### BRIEF DESCRIPTION OF THE DRAWINGS

For a better understanding of the present invention and to show more clearly how it may be carried into effect, reference is made by way of example to the accompanying drawings in which:

FIG. 1 is a perspective view of an embodiment of an electrically conductive block of the present invention;

FIG. 2 is a section view of an embodiment of an electrically conductive pressure stud of the present invention;

FIG. 3 is a perspective view of another embodiment of an electrically conductive block of the present invention;

FIG. 4 is perspective view of an embodiment of an electrical connector between two pressure studs;

FIG. 5 is a longitudinal section along plane A-A of the block of FIG. 3 with the electrical connector of FIG. 4;

FIG. 6 is perspective view of another embodiment of an electrical connector between two pressure studs;

FIG. 7 is a longitudinal section along plane A-A of the block of FIG. 3 where such block has the electrical connector of FIG. 6;

FIG. 8 is a perspective view of another embodiment of an electrically conductive block which comprises two parts that can be press fit together with the pressure studs and electrical connector during assembly;

FIG. 9 is a longitudinal section along plane B-B of the block of FIG. 8;

FIG. 10 is a longitudinal section of another embodiment of an electrically conductive block having four electrically conductive pressure studs that are electrically connected to each other;

FIG. 11 is perspective view of the electrical connector between four pressure studs of the block of FIG. 10;

FIG. 12 is a longitudinal section of another embodiment of an electrically conductive block having two electrically conductive pressure studs that are electrically connected to each other;

FIG. 13 is perspective view of the electrical connector between two pressure studs of the block of FIG. 12;

FIG. 14 is perspective view from the top of a building block of the present invention housing an electric motor;

FIG. 15 is perspective view from the bottom of a building block of the present invention housing an electric motor;

FIG. 16 is a perspective view of three electrically conductive blocks of the present invention that are physically and electrically connected;

FIG. 17 is a perspective view of two electrically conductive blocks of the present invention that are electrically connected via an external electrical connector;

FIG. 18 is a perspective view of an embodiment of the external electrical connector shown in FIG. 17; and

FIG. 19 is a perspective view of several electrically conductive blocks of the present invention that are physically and electrically connected to define an electrical circuit with a battery.

### DETAILED DESCRIPTION

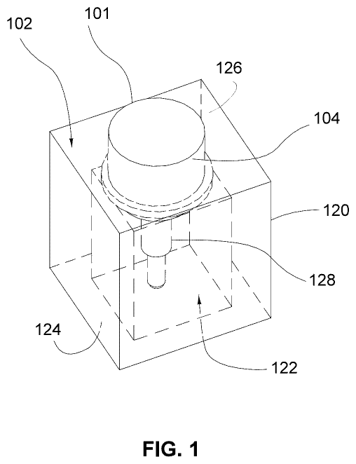

Referring to FIG. 1, there is shown an embodiment of an electrically conducting toy building block 102 in accordance with the present invention. Block 102 is the simplest embodiment of a electrically conducting toy building block defining a single electrical connector comprising of an electrically conductive connector stud or pressure stud 101. The pressure stud 101 includes a top portion such as cylindrical top 104 that extends above a top surface 126 of the block 102. The block body 120 defines a lower internal cavity 122 that is open to the bottom surface 124 and is sized to accommodate the top 104 of the pressure stud 101 on another block 102 for friction fit therebetween such that multiple blocks 102 can be connected in a manner that each top 104 of the pressure stud 101 is frictionally engaged within the cavity 122 of an adjacent block 120 above it.

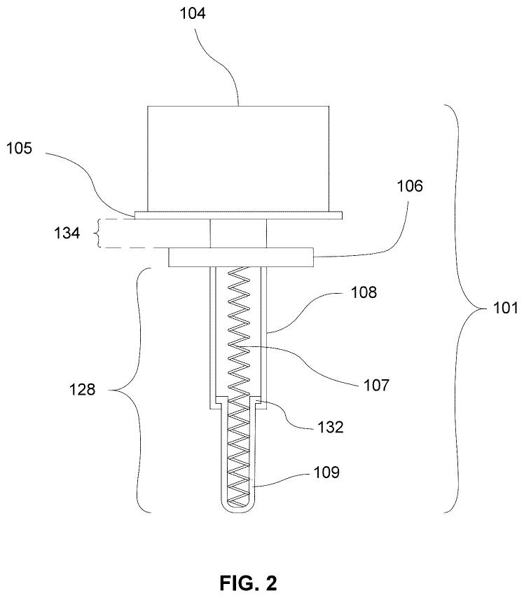

Each pressure stud 101 may be made of a conductive material such as copper, or alternatively it may be covered in a conductive material such as gold-plated Nickel, so that the pressure stud 101 conducts electricity along its length. With reference to FIG. 2, each pressure stud 101 includes a cylindrical top 104 that is configured to fit inside a standard building block, such as building blocks known as LEGO™, and to stay in place due to friction. This enables the electrically conductive building blocks of the present invention to be used and connected to such standard building blocks to provide electrical connectivity in structures built primarily of standard building blocks. The pressure stud 101 includes an elongate telescoping member or pressure pin 128 that extends downward from a central axis of the bottom surface of the top 104. The pressure pin includes a lower inner plunger 109 that is slidably received within an outer barrel 108 and includes a stop 132 that limits the length of the pressure pin 128 and prevents complete withdrawal of the plunger from the outer barrel. A coil spring 107 within the pressure pin 128 provides spring bias to urge the plunger 109 to extended from the barrel 108 until the engagement of the stop 132 thereby urging the pressure pin 128 to be in its longest configuration. The spring 107 allows the plunger 109 to be pressed into the barrel 108 to allow for shortening of the pressure pin length.

With a pressure stud 101 operably mounted within a block 102, the pressure pin 128 is within the inner cavity 122 and preferably extends to being slightly short of a plane defined by the bottom surface 124. Hence the length of the pressure stud 101 is such that when two electrically conductive building blocks 102 of the present invention are connected to each other, the top 104 of the lower block presses against the plunger 109 of the block above it so that both pressure studs 101 are electrically connected. In some embodiments, the pressure stud may include the circumferential flange 105 adjacent the bottom of the top 104 and extending beyond the top's periphery. The flange 105 may hold the stud 101 within the plastic block 102 and may also define a channel 134 with a ring portion 106 that may be provided at a distance below the flange 105.

Although a spring is shown, liquids and gasses under pressure along with naturally compressive substances could be used to create the bias pressure that urges the plunger 109 outward of the barrel 108.

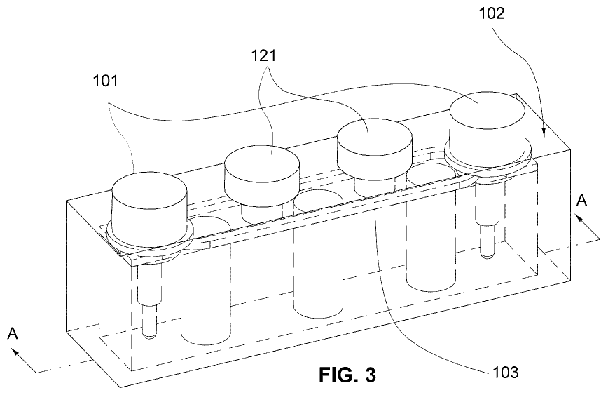

With reference to FIG. 3, another embodiment of an electrically conductive block of the present invention is shown. In this embodiment, block 102 is rectangular with a row of four cylindrical connector studs protruding from the top face, wherein the connector studs at each end are provided by tops 104 of pressure studs 101, and the middle connector studs 121 are non-conductive and comprise of plastic cylindrical protrusions known in the prior art blocks such as LEGO™. Hence, in the embodiment shown, the two connector studs on the outsides are electrically conductive (pressure studs 101), while two studs between them are not electrically conductive.

The number of total studs can vary in both the number of studs in a row as well as the number of rows of studs. For example, the block could be two rows wide and three studs long or it could just be a block with one stud. At a minimum, one stud has to be conductive, as shown in FIG. 1.

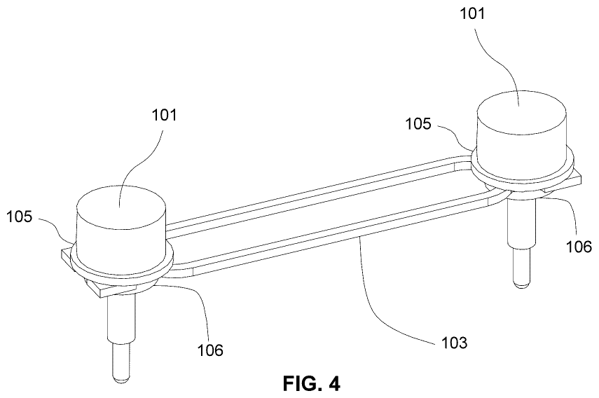

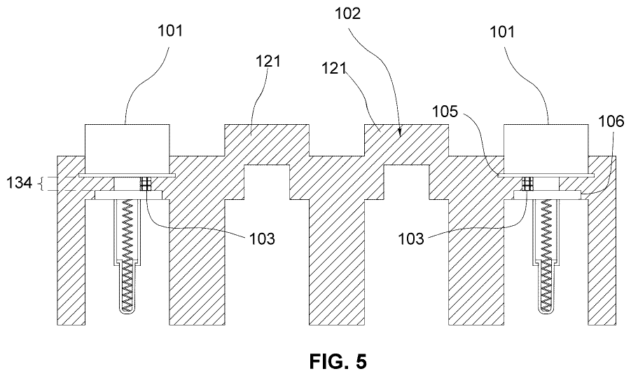

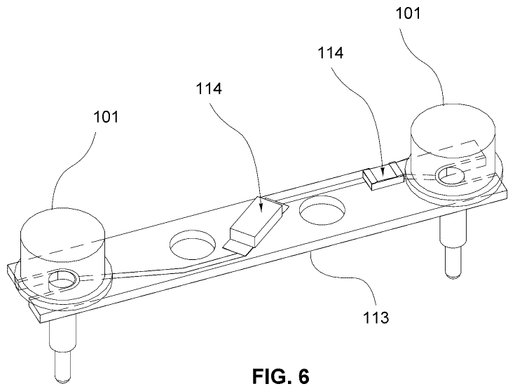

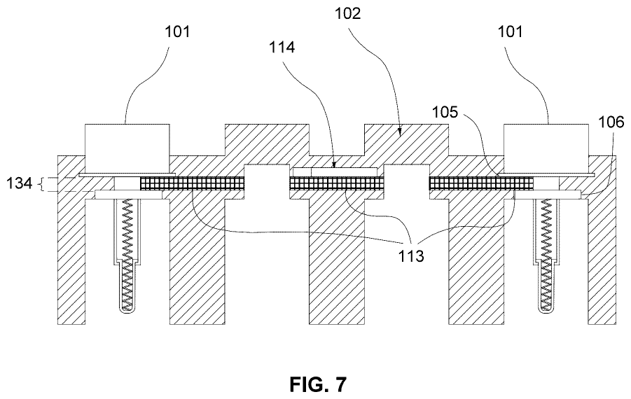

Also shown in FIG. 3 is an electrically conductive element that creates an electrical connection within the block between the two electrically conductive pressure studs 101. Multiple pressure studs 101 may be connected by an electrical conductor 103. For example, in some embodiments, the electrical conductor 103 may be received in the channel 134 defined by the ring 106 and flange 105 if such structures are present, as shown in FIGS. 3-5. In other embodiments, the pressure studs may simply be received in a hole provided in the electrical conductor 103. In some embodiments, the pressure studs 101 can be connected by a PCB board 113 with a circuit as shown in FIG. 6 that may or may not contain additional electronic components 114. For example, FIG. 7 shows a longitudinal section of a four pin block showing the pressure studs 101 connected by a PCB board 113 in an injection molded block body.

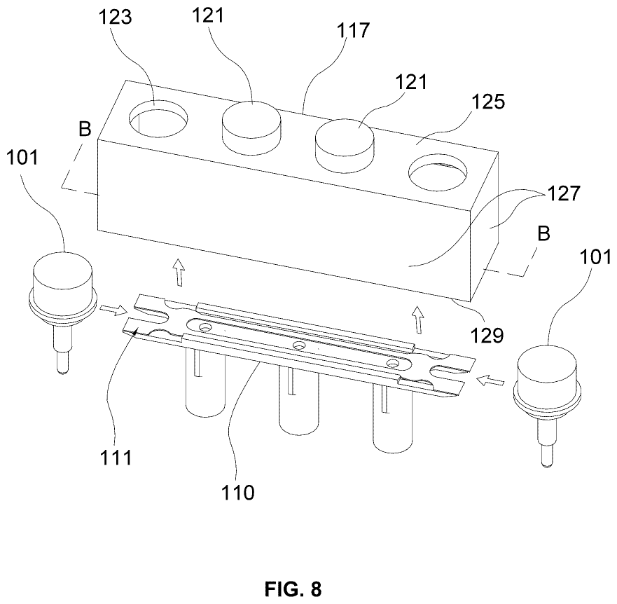

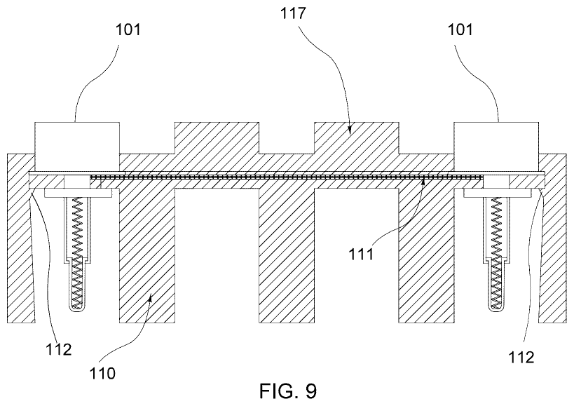

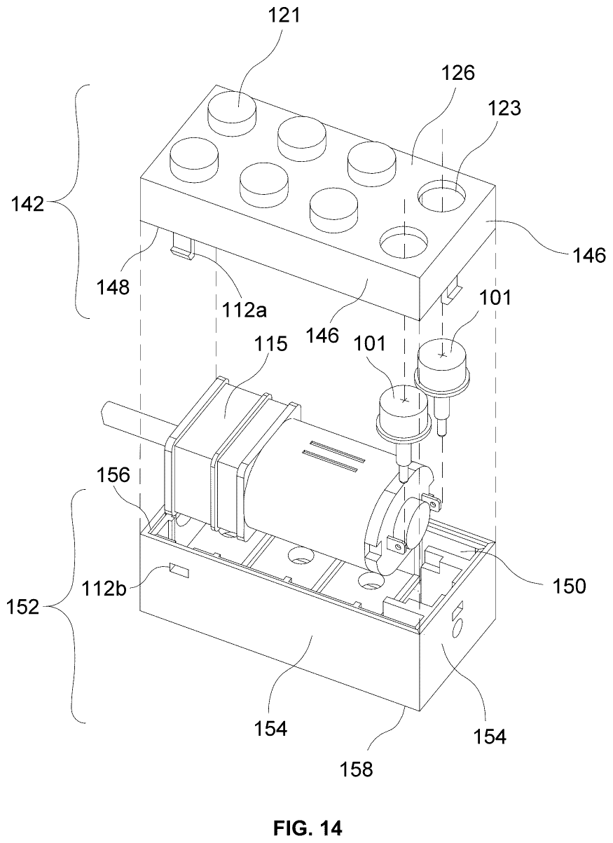

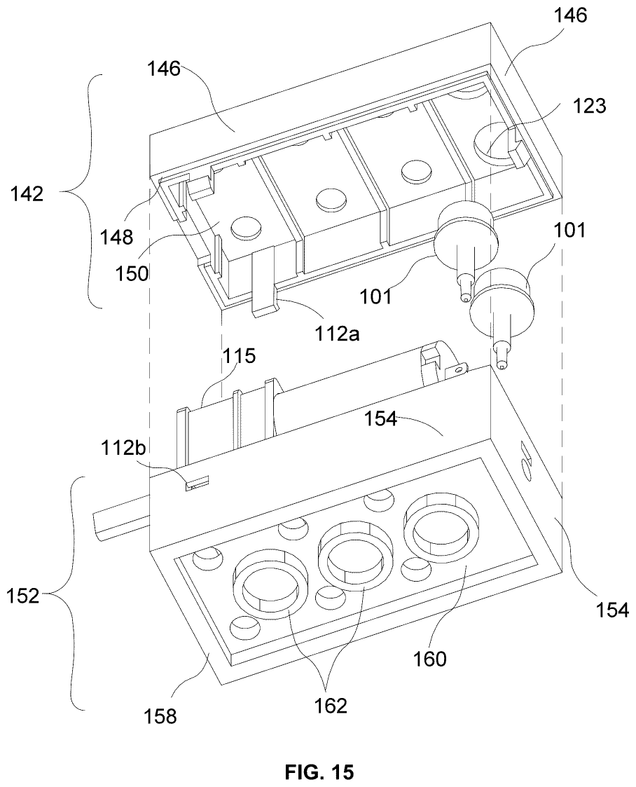

The pressure studs 101 may be formed into the building block body as part of the injection molding process of the thermoplastic materials from which the body of the block is constructed. Or the pressure studs 101 may be inserted during assembly of each individual block in the embodiment of a block that is made in two parts and snapped together afterwards as shown in FIG. 8. This construction is shown in FIG. 8 with pressure studs 101 sliding into an internal member such as a preformed thermoplastic block 110 with the conductive connector inset 111 and then inserted in the external body 117 that defines the top of the block and snapping in place with a clip mechanism such as small clips 112 set into the wall of the external body 117. The top portion of the pressure pin 101 protrudes through hole 123 on the top wall 125 of the external body 117. The external body 117 has side walls 127 that define a bottom edge 129 and that bounds the cavity. FIG. 9 shows a section through the final snapped together two-piece block. In FIGS. 14 and 15 there is shown another embodiment of a clip mechanism comprising a clasp portion 112a that mates with and is captured by a complementary depression 112b.

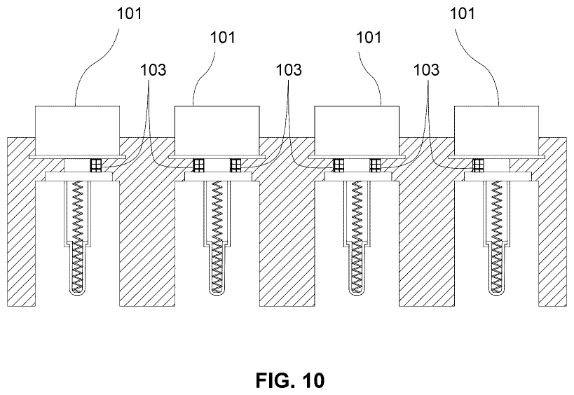

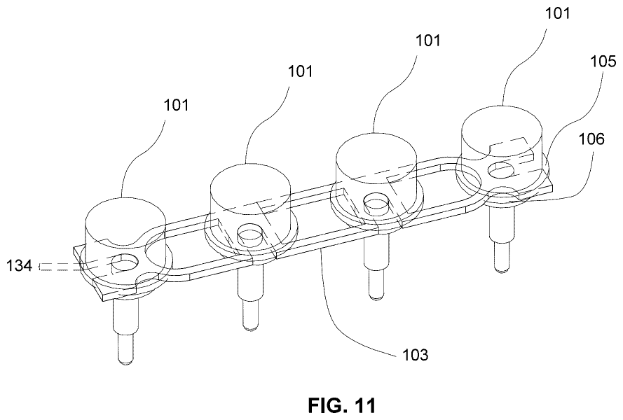

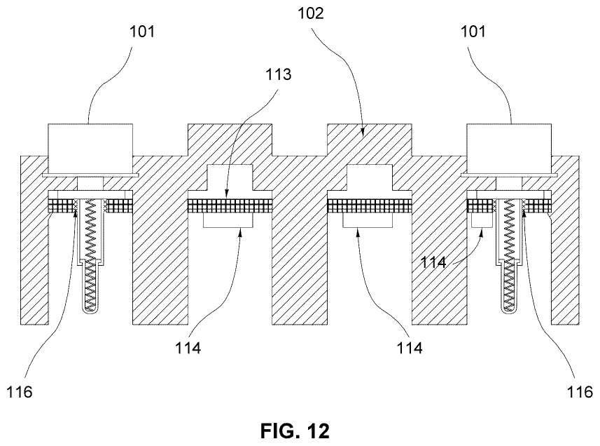

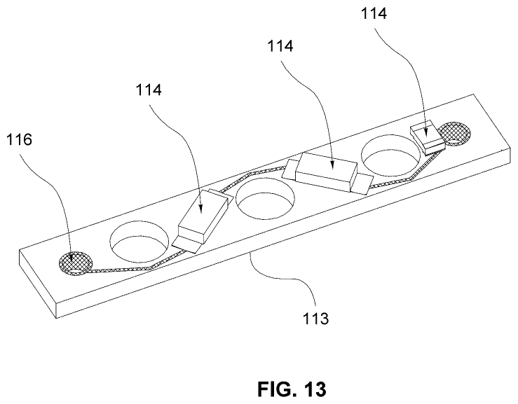

The number of pressure studs 101 may be variable and may depend on the purpose of the block, and is not limited to, but includes blocks that only have one stud (see FIG. 1), two studs (see FIG. 3) and four studs (see FIG. 10). Any number of pressure studs could be connected within the injection molded block over a conductor 103 (see FIG. 11) or they may not be connected at all within the pressure molded block (see FIG. 12), in which case the connection between studs could be with a snap in place PCB board 113 (see FIG. 13) that will contain a circuit and may or may not contain electrical components 114. In this case, the PCB board will connect with the body of the pins using a circular conductive connector 116. The purpose of the single pin blocks or the blocks without connected pins is to extend the current between the top and the bottom of the block without carrying it through the block to another pin. The blocks with conductive connectors set inside of them allow the current to be carried both vertically from the top of the block to the bottom (and vice versa) as well laterally along the block. This allows for any combination of three-dimensional circuits to be created with sets of blocks.

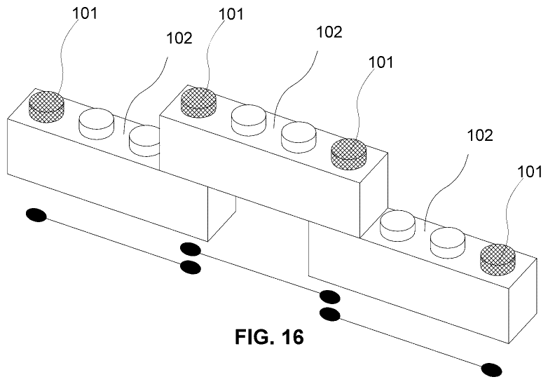

As mentioned, the method and structure of electrically connecting the studs 101 can vary depending on the embodiment and could for example be achieved with a PCB board connected at each end to one of the studs (FIG. 6), connected to multiple electrically conductive studs (FIG. 11) or connected through a snap in place PCB board (FIG. 13), in which case no electrical connector is cast in place within the block. A key element of the electrically conductive studs (FIG. 2) is the spring loaded or biased plunger 109 which is electrically connected to the stud on which it is a part. This creates an additional electrical connection for the block going from the top of the block to the bottom. This may or may not connect to another stud attached below. The preferred embodiment will carry a current from one stud to the other and from the top of each stud to the bottom allowing for multiple configurations in a circuit made of these blocks, or to just carry a current between two blocks like a wire made of plastic toy building blocks (FIG. 16).

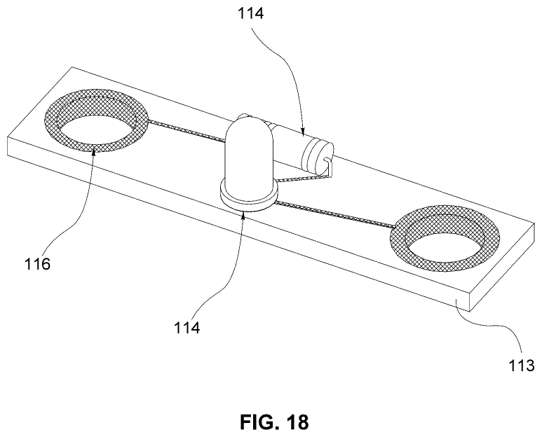

Pressure studs 101 may be used within components (see FIGS. 14 and 15) to create an electrically conductive pathway to electronic components or devices such as motors 115, batteries and servo motors. The devices, such as motors, batteries and servo motors, may be housed inside custom injection molded bodies that specifically hold them and allow for the pressure studs 101 to extend out of the top or the bottom of the block. The block in the illustrated embodiment comprises a top portion 142 having a top wall 126 and first side walls 146 the top wall defining a top surface 126, and the first side walls defining a first bottom edge 148 and the top wall and first side walls bounding a first cavity 150 to receive an electronic component. The block further comprises a bottom portion 152 having second side walls 154 defining a top edge 156 and a second bottom edge 158 the second side walls bounding a second cavity 160. The bottom portion being connected to the top portion in a manner such that the fist side walls 146 align with the second side walls 154 to create a unified block. The top portion and the bottom portion may be preferably secured together by a clip mechanism, such as clasp portion 112a on the first bottom edge 148 that mates with and is captured by a complementary depression or void 112b on the second side walls 154. The bottom portion includes the second cavity 160 that has a equally spaced projections 162 extending into the second cavity 160 wherein the equally spaced projections define engagement portions in the second cavity that frictionally engage the connector studs of another block for friction fit therebetween such that multiple blocks can be connected in a manner that each connector stud is frictionally engaged within the second cavity of an adjacent block. Hence custom injection molded bodies of these components may also contain standard studs projecting from the top as well as cavities in the bottom with the intention of connecting to other blocks. As pointed out, the pressure studs will be entirely conductive. In addition to connecting to components, these studs may be connected to circular connector 116 enabled circuit boards such as the one shown in FIG. 18 and be engaged with that connector through mechanic methods (soldering) or they may be connected to a circuit board such as the one shown in FIG. 6 and be engaged with that connector through friction.

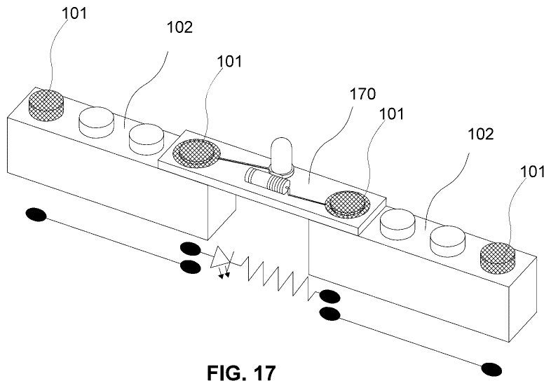

Examples of the role that the electrically conductive building blocks of the present invention can play are shown in FIGS. 16 and 17. The electronically conductive connections are shown in a hatched pattern and a circuit diagram is shown below each of the units using universally standard graphics. In the top example (FIG. 16) the embodiment of a block 102 can be snapped on top of and below identical pieces but offset so the conductive stud at the opposite end of each block is attached. This can be done repeatedly to carry the current from block to block. Shown in the FIG. 17 are two blocks 102 that are connected by a circular connector enabled circuit board 170. The current in this diagram would pass through the block and into the circular connector enabled circuit board 170 and through that to the next block. FIG. 18 shows a potential circular connector enabled circuit board. In this case it is a PCB board with a circuit that connects from one hole to a resistor, then an LED and finally the remaining hole.

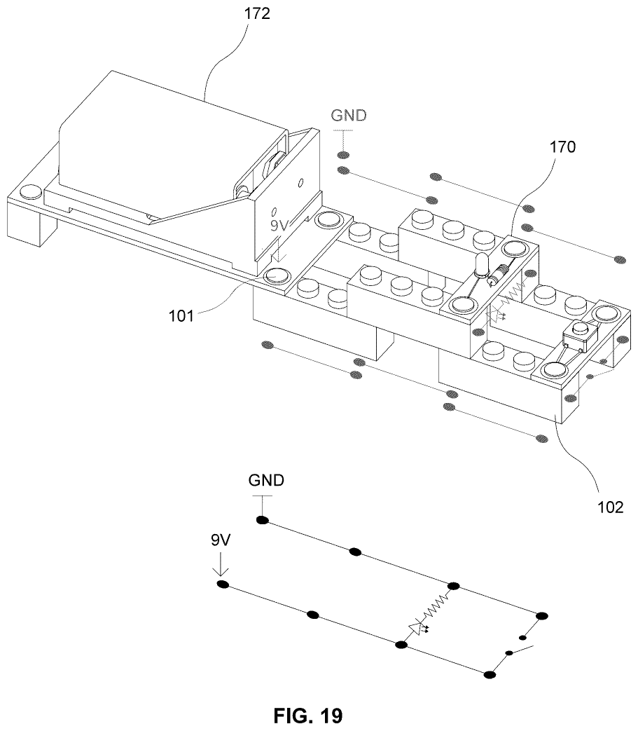

In FIG. 19 an entire circuit is shown using the blocks 102 and circular connector enabled circuit boards 170. The elements are labeled with the symbols of a circuit diagram and the circuit itself is drawn out below. From six blocks 102 and two circular connector enabled circuit boards along with a sufficient current, a remarkably interesting circuit can be built. In the case of FIG. 19 one of the circular connector enabled circuit boards 170 is a connected to a battery 172, such as a 9 volt battery, that creates the current required to run the circuit. There is no limit to the variety of possible circular connector enabled circuit boards 170 and they include not only everything shown so far, but also include, for example, micro controllers and any components used to drive them, engine controllers and any components used to drive them, switches, sensors and potentiometers, to name just a few. The circular connector enabled circuit boards 170 contain at least two circular conductive holes set in the same pattern and location as the studs in the building block system, but there is no limit to how many holes may be in any one board.

The embodiments described and illustrated in this document provide non-limiting examples of possible implementations of the present invention. Upon review of the present disclosure, a person of ordinary skill in the art will recognize that changes may be made to the embodiments described and illustrated herein without departing from the scope of the present invention.

1. An electrically conducting toy building block comprising:
a. a body having a top surface and a bottom surface, and a plurality of evenly spaced connector studs projecting from the top surface;
b. the body defining an internal cavity that is open to the bottom surface and is sized to accommodate the top surface of another block and frictionally engage the connector studs of said other block for friction fit therebetween such that multiple blocks can be connected in a manner that each connector stud is frictionally engaged within the cavity of an adjacent block;
c. wherein the connectors studs comprise at least one electrically non-conductive connector stud and at least one electrically conductive connector stud;
d. wherein the electrically conductive connector stud comprises:
i. a top portion having external dimensions matching the non-electrically conducting connector stud;
ii. an elongate telescoping member that extends downward from the top portion into the cavity, the telescoping member having an outer barrel and an inner plunger that is slidably received in the barrel, the plunger including a stop member to prevent complete withdrawal of the plunger from the barrel, the plunger being biased towards being extended from the barrel; and
iii. the telescoping member having a length that when the plunger is fully extended from the barrel, a bottom of the plunger is within the cavity proximate the bottom surface, and when the block is connected to the top surface of said another block one of the connector studs on said another block contacts the bottom of the plunger and urges the plunger inward.

2. The electrically conducting toy building block as claimed in claim 1, further comprising a spring connected to the plunger to bias the plunger towards being extended from the barrel.

3. The electrically conducting toy building block as claimed in claim 1, further comprising a coil spring within the telescoping member and connected to the plunger to bias the plunger towards being extended from the barrel.

4. The electrically conducting toy building block as claimed in claim 1, comprising at least two electrically conductive connector studs.

5. The electrically conducting toy building block as claimed in claim 4, further comprising an electrically conductive element connecting the at least two electrically conductive connector studs.

6. The electrically conducting toy building block as claimed in claim 5, wherein the electrically conductive element comprises an integrated circuit board having an electrical circuit connecting the at least two electrically conductive connector studs.

7. An electrically conducting toy building block comprising:
a. an external body having a top wall and side walls, the top wall defining a top surface, and the side walls defining a bottom edge, and the top wall and side walls bounding a cavity;
b. a plurality of non-conductive connector studs projecting from the top surface and evenly spaced thereon, and a plurality of holes in the top wall evenly spaced from adjacent non-conductive connector studs of the plurality of non-conductive connector studs;
c. a plurality of electrically conductive connector studs within the cavity, each electrically conductive connector stud of the plurality of electrically conductive connector studs having a top portion protruding through one of the plurality of holes, the top portion having external dimensions matching the non-electrically conducting connector studs, each electrically conductive connector stud of the plurality of electrically conductive connector studs further having an elongate telescoping member that extends downward from the top portion within the cavity, the telescoping member having an outer barrel and an inner plunger that is slidably received in the barrel, the plunger including a stop member to prevent complete withdrawal of the plunger from the barrel, the plunger being biased towards being extended from the barrel; and the telescoping member having a length that when the plunger is fully extended from the barrel, a bottom of the plunger is within the cavity proximate a bottom surface defined by the bottom edge;
d. an electrically conductive element within the cavity adjacent the top wall, the electrically conductive element providing an electric circuit between at least two of the plurality of electrically conductive connector studs;
e. an internal member within the cavity adjacent the electrically conductive element, the internal member having equally spaced projections extending into the cavity, wherein the equally spaced projections define at least a portion of a plurality of engagement portions in the cavity that frictionally engage the connector studs of said other block for friction fit therebetween such that multiple blocks can be connected in a manner that each connector stud is frictionally engaged within the cavity of an adjacent block; and
f. wherein when the block is connected to the top surface of said another block the bottom of the plunger may be urged inward by contact with an electrically conductive connector stud on said another block.

8. The electrically conducting toy building block as claimed in claim 7, further comprising a spring connected to the plunger to bias the plunger towards being extended from the barrel.

9. The electrically conducting toy building block as claimed in claim 7, further comprising a coil spring within the telescoping member and connected to the plunger to bias the plunger towards being extended from the barrel.

10. The electrically conducting toy building block as claimed in claim 7, further comprising a clip mechanism cooperating with the external body and the internal member to secure the internal member to the external body within the cavity.

11. The electrically conducting toy building block as claimed in claim 10, wherein the clip mechanism comprises a clasp portion on the side walls within the first cavity that captures the internal member upon the internal member being pressed into the first cavity.

12. An electrically conducting toy building block comprising:
a. a top portion having a top wall and first side walls, the top wall defining a top surface, and the first side walls defining a first bottom edge, and the top wall and first side walls bounding a first cavity to receive an electronic component;
b. a bottom portion having second side walls defining a top edge and a second bottom edge, the second side walls bounding a second cavity;
c. the bottom portion being connected to the top portion in a manner that the top edge abuts the first bottom edge and the fist side walls align with the second side walls to create a unified block;
d. a plurality of non-conductive connector studs projecting from the top surface and evenly spaced thereon, and a plurality of holes in the top wall evenly spaced from adjacent non-conductive connector studs of the plurality of non-conductive connector studs;
e. a plurality of electrically conductive connector studs within the cavity, each electrically conductive connector stud of the plurality of electrically conductive connector studs having a top portion protruding through one of the plurality of holes, the top portion having external dimensions matching the non-electrically conducting connector studs, each electrically conductive connector stud of the plurality of electrically conductive connector studs further having an elongate telescoping member that extends downward from the top portion within the first cavity and the second cavity, the telescoping member having an outer barrel and an inner plunger that is slidably received in the barrel, the plunger including a stop member to prevent complete withdrawal of the plunger from the barrel, the plunger being biased towards being extended from the barrel, and the telescoping member having a length that when the plunger is fully extended from the barrel, a bottom of the plunger is within the second cavity proximate a bottom surface defined by the second bottom edge;
f. the second cavity having equally spaced projections extending into the cavity, wherein the equally spaced projections define at least a portion of a plurality of engagement portions in the cavity that frictionally engage the connector studs of said other block for friction fit therebetween such that multiple blocks can be connected in a manner that each connector stud is frictionally engaged within the cavity of an adjacent block; and
g. wherein when the block is connected to the top surface of said another block the bottom of the plunger may be urged inward by contact with an electrically conductive connector stud on said another block.

13. The electrically conducting toy building block as claimed in claim 12, further comprising a spring connected to the plunger to bias the plunger towards being extended from the barrel.

14. The electrically conducting toy building block as claimed in claim 12, further comprising a coil spring within the telescoping member and connected to the plunger to bias the plunger towards being extended from the barrel.

15. The electrically conducting toy building block as claimed in claim 12, further comprising a clip mechanism cooperating with the top portion and the bottom portion to secure the top portion to the bottom portion.

16. The electrically conducting toy building block as claimed in claim 15, wherein the clip mechanism comprises a clasp portion extending from the first bottom edge and a complementary aligned void on the second side wall that captures the clasp portion as the bottom portion is pressed into abutment with the top portion.
